(19) United States
(12) Patent Application Publication
(10) Pub. No.: US 2023/0144902 A1
(43) Pub. Date: May 11, 2023

(54) SAMARIUM-IRON-NITROGEN BASED MAGNET AND SAMARIUM-IRON-NITROGEN BASED MAGNET POWDER

(71) Applicants: Ryuji HASHIMOTO, Tokyo (JP); Yasushi ENOKIDO, Tokyo (JP); Shusuke OKADA, Aichi (JP); Kenta TAKAGI, Aichi (JP)

(72) Inventors: Ryuji HASHIMOTO, Tokyo (JP); Yasushi ENOKIDO, Tokyo (JP); Shusuke OKADA, Aichi (JP); Kenta TAKAGI, Aichi (JP)

(73) Assignee: TDK Corporation, Tokyo (JP)

(21) Appl. No.: 17/907,564

(22) PCT Filed: Mar. 29, 2021
(86) PCT No.: PCT/JP2021/013325

§ 371 Date: Sep. 28, 2022

(30) Foreign Application Priority Data
Mar. 30, 2020 (JP) 2020-060803

(51) Int. Cl. H01F 1/059

(52) U.S. Cl. CPC H01F 1/059

(57) ABSTRACT

A samarium-iron-nitrogen based magnet, wherein a samarium oxide phase is formed on at least a part of a surface of a crystal grain, and wherein an atomic ratio of calcium to a total amount of iron group elements, rare earth elements, and calcium is 0.4% or less.

### TECHNICAL FIELD

The present invention relates to a samarium-iron-nitrogen based magnet and a samarium-iron-nitrogen based magnet powder.

### BACKGROUND ART

Neodymium-iron-boron magnets are currently used in a variety of applications as high-performance magnets.

However, because the neodymium-iron-boron magnet has a low Curie temperature of 312° C. and low heat resistance, it is necessary to add dysprosium for use in environments exposed to high temperatures such as motors. Dysprosium has a low production volume and limited production areas, and there are concerns about its supply.

Therefore, a samarium-iron-nitrogen magnet is known as a magnet that does not contain dysprosium and has high heat resistance.

The samarium-iron-nitrogen magnet has a saturation magnetization equivalent to that of the neodymium-iron-boron magnet, has a high Curie temperature of 477° C., has a small temperature change in the magnet characteristics, and has a very high anisotropic magnetic field of 260 kOe, which is about three times greater than that of the neodymium-iron-boron magnet, which is the theoretical value of coercivity.

In order to increase the coercivity of the samarium-iron-nitrogen magnet, it is necessary to increase the coercivity of the samarium-iron-nitrogen magnet powder.

PTL 1 discloses a samarium-iron-nitrogen magnet powder in which a non-magnetic phase is formed on the surface of the samarium-iron-nitrogen magnet phase and the arithmetic mean roughness Ra is 3.5 nm or less.

### CITATION LIST

### Patent Literature

### [PTL 1]

WO 2018/221512

### SUMMARY OF INVENTION

### Technical Problem

However, when a conventionally proposed samarium-iron-nitrogen magnet powder is sintered to produce a samarium-iron-nitrogen magnet, the coercivity of the samarium-iron-nitrogen magnet decreases.

One aspect of the present invention is to provide a samarium-iron-nitrogen based magnet having high coercivity.

It is known that when the average particle size of the magnet powder decreases, the coercivity typically increases. Accordingly, it is an object of one embodiment of the present invention to provide a samarium-iron-nitrogen based magnet having higher coercivity than a conventional one even with comparable average particle size.

### Solution to Problem

One aspect of the present invention is: a samarium-iron-nitrogen based magnet, wherein a samarium oxide phase is formed on at least a part of a surface of a crystal grain, and wherein an atomic ratio of calcium to a total amount of iron group elements, rare earth elements, and calcium is 0.4° or less.

Another aspect of the present invention is: a samarium-iron-nitrogen based magnet powder, wherein a samarium oxide phase is formed on at least a part of a surface of a crystal grain, and wherein an atomic ratio of calcium to a total amount of iron group elements, rare earth elements, and calcium is 0.4% or less.

### Advantageous Effects of Invention

According to one aspect of the present invention, a samarium-iron-nitrogen based magnet having high coercivity can be provided.

### BRIEF DESCRIPTION OF THE DRAWINGS

FIG. 1 is a flowchart illustrating a method of manufacturing a samarium-iron-nitrogen based magnet powder according to the present embodiment;

FIG. 2 is a flowchart illustrating a method of manufacturing a samarium-iron-nitrogen based magnet according to the present embodiment;

FIG. 3 is a STEM image of a cross-section of a samarium-iron-nitrogen based magnet powder of Example 1; and

FIG. 4 is a result of line analysis of the cross-section of the samarium-iron-nitrogen based magnet powder of Example 1.

### DESCRIPTION OF EMBODIMENTS

Hereinafter, embodiments of the present invention will be described.

The present invention is not limited to the contents described in the following embodiments. The components described in the following embodiments include those that can be easily assumed by those skilled in the art based on the components and those that are substantially the same as the components. Additionally, the components described in the following embodiments may be combined as appropriate.

As a result of the intensive investigation by the inventors, the inventors have found the following and completed the present invention. In the manufacturing process of the samarium-iron-nitrogen based magnet powder, the nitride of the samarium-iron based alloy powder is washed with a selective acid, such as amidosulfuric acid, N-alkyl amidosulfuric acid, and the like, thereby removing the unreacted calcium and calcium oxide as a by-product thereof (hereinafter, referred to as a calcium compound). As a result, the samarium-iron-nitrogen based magnet powder that can reduce the decrease in coercivity when sintering is obtained.

The nitride of the samarium-iron based alloy powder is obtained by reducing and diffusing a precursor powder of a samarium-iron based alloy described later to obtain the samarium-iron based alloy powder, and then nitriding the samarium-iron based alloy powder.

It is considered that the calcium compound can be selectively removed by the selective acid because the selective acid described above is not likely to react with a samarium oxide phase (subphase) that is formed on the surface (main phase) of the crystal grain or formed on at least a part of the surface of the crystal grain, the crystal grain constituting the nitride of the samarium-iron based alloy powder.

By washing the nitride of the samarium-iron based alloy powder with the selective acid described above, the atomic ratio of calcium to the total amount of iron group elements, rare earth elements, and calcium in the samarium-iron-nitrogen based magnet powder and in the samarium-iron-nitrogen based magnet can be reduced to 0.4% or less. Therefore, the decrease of coercivity when the samarium-iron-nitrogen magnet powder is sintered can be reduced, and as a result, a samarium-iron-nitrogen based magnet having high coercivity is obtained.

By washing the nitride of the samarium-iron based alloy powder with the selective acid described above, the samarium oxide phase is formed on at least a part of the surface of the crystal grain. Accordingly, the defect in the surface of the crystal grain is reduced and the samarium-iron-nitrogen magnet powder having high coercivity can be obtained. As a result, the samarium-iron-nitrogen based magnet having high coercivity can be obtained.

### [Samarium-Iron-Nitrogen Based Magnet]

In the samarium-iron-nitrogen based magnet according to the present embodiment, a samarium oxide phase is formed on at least a part of the surface of the crystal grain.

As used herein and in the claims, the term samarium-iron-nitrogen based magnet means a magnet containing samarium, iron, and nitrogen.

The samarium-iron-nitrogen based magnet according to the present embodiment may further include, in the crystal grain and/or in the samarium oxide phase, a rare earth element other than samarium, such as neodymium, praseodymium, and an iron group element other than iron, such as cobalt.

Each of the content of the rare earth element other than samarium in all rare earth elements and the content of the iron group element other than iron in all iron group elements is preferably less than 30 at %, from the viewpoint of anisotropic magnetic field and magnetization.

In the samarium oxide phase, the atomic ratio of the rare earth element to the iron group element is larger than that in the crystal grain.

The samarium oxide phase is a phase obtained by oxidizing a samarium-rich phase.

The atomic ratio of calcium to the total amount of iron group elements, rare earth elements, and calcium of the samarium-iron-nitrogen based magnet according to the present embodiment is 0.4% or less, and more preferably 0.25% or less. When the atomic ratio of calcium to the total amount of iron group elements, rare earth elements, and calcium of the samarium-iron-nitrogen based magnet exceeds 0.4%, the coercivity of the samarium-iron-nitrogen based magnet decreases.

The average particle size of the crystal grain is preferably less than 2.0 μm. When the average particle size of the crystal grain is less than 2.0 μm, the coercivity of the samarium-iron-nitrogen based magnet according to the present embodiment further increases.

The proportion of the crystal grains having an aspect ratio of 2.0 or more in the crystal grain is preferably 10 number % or less, and further preferably 8 number % or less. When the proportion of the crystal grains having an aspect ratio of 2.0 or more is 10 number S or less, the coercivity of the samarium-iron-nitrogen based magnet according to the present embodiment further increases.

The arithmetic mean roughness Ra of the crystal grain is preferably 3.5 nm or less, and further preferably 2.0 nm or less. When the arithmetic mean roughness Ra is 3.5 nm or less, the coercivity of the samarium-iron-nitrogen based magnet according to the present embodiment further increases.

The arithmetic mean roughness Ra may be measured using a transmission electron microscope (TEM) or a scanning transmission electron microscope (STEM).

When the surface on which the arithmetic mean roughness Ra is measured (hereinafter referred to as a measurement surface) is a cross section, the arithmetic mean roughness Ra can be obtained based on the definition of the arithmetic mean roughness Ra in JIS B0601.

Specifically, a roughness curve is obtained by obtaining an mean line (waviness curve) from the cross-sectional curve of the measurement surface and subtracting the mean line from the cross-sectional curve, that is, by replacing the mean line with a straight line. Then, according to the coordinate system defined in JIS B0601, the direction that coincides with the mean line replaced by the straight line is defined as the X-axis, and the direction that is perpendicular to the X-axis and parallel to the cross section is defined as the Z-axis. Only a sampling length l (el) in the direction of the X-axis is extracted from the roughness curve. The mean line in the extracted part can be represented by the following formula (1).

$$\begin{matrix}[ Formula 1 ] & \\ {Z}_{0} = \frac{1}{l} {\int }_{0}^{l} Z ( x ) dx & FORMULA ( 1 )\end{matrix}$$

Here, the arithmetic mean roughness Ra is a value obtained by averaging absolute values of deviations between Z(x) and Z₀, and can be obtained by the following formula (2).

$$\begin{matrix}[ Formula 2 ] & \\ R a = \frac{1}{l} {\int }_{0}^{l} \vert Z ( x ) - {Z}_{0} \vert dx & FORMULA ( 2 )\end{matrix}$$

Specifically, for example, using a microscope capable of high-magnification observation such as TEM, the cross-section of the measurement surface is observed, and a mean line and a roughness curve are obtained from the cross-sectional curve. A region of 150 nm is freely selected on the X-axis, 50 X values (X₁ to X₅₀) are taken at regular intervals in the selected region, and Z values (Z(x₁) to Z(x₅₀)) are measured at each X value. From the measured Z values, Z₀ can be obtained by the following formula (3).

Z₀=(1/50)×{Z(x₁)+Z(x₂)+Z(x₃)+ . . . +Z(x₅₀)} (3)

Using the obtained Z₀, the arithmetic mean roughness Ra can be obtained by the following formula (4).

Ra=(1/50)×{|Z(x₁)−Z₀|+|Z(x₂)−Z₀|= . . . +|Z(x₅₀)−Z₀|} (4)

The oxygen content of the samarium-iron-nitrogen based magnet in the present embodiment is preferably less than 1.0% by mass. When the oxygen content of the samarium-iron-nitrogen based magnet according to the present embodiment is less than 1.0% by mass, the coercivity of the samarium-iron-nitrogen based magnet according to the present embodiment further increases.

The crystal structure of the crystal grain of the samarium-iron-nitrogen based magnet according to the present embodiment may be either Th₂Zn₁₇ structure or TbCu₇ structure, but the Th₂Zn₁₇ structure is preferable.

### [Samarium-Iron-Nitrogen Based Magnet Powder]

In the samarium-iron-nitrogen based magnet powder according to the present embodiment, a samarium oxide phase is formed on at least a part of the surface of the crystal grain.

As used herein and in the claims, the term samarium-iron-nitrogen based magnet powder means a magnetic powder containing samarium, iron, and nitrogen.

The samarium-iron-nitrogen based magnet powder according to the present embodiment may further include, in the crystal grain and/or in the samarium oxide phase, a rare earth element other than samarium, such as neodymium, praseodymium, and an iron group element other than iron, such as cobalt.

Each of the content of the rare earth element other than samarium in all rare earth elements and the content of the iron group element other than iron in all iron group elements is preferably less than 30 at %, from the viewpoint of anisotropic magnetic field and magnetization.

In the samarium oxide phase, the atomic ratio of the rare earth element to the iron group element is larger than that in the crystal grain.

The samarium oxide phase is a phase obtained by oxidizing a samarium-rich phase.

The atomic ratio of calcium to the total amount of iron group elements, rare earth elements, and calcium of the samarium-iron-nitrogen based magnet powder according to the present embodiment is 0.4% or less, and more preferably 0.25% or less. When the atomic ratio of calcium to the total amount of iron group elements, rare earth elements, and calcium of the samarium-iron-nitrogen based magnet powder exceeds 0.4%, coercivity of the samarium-iron-nitrogen based magnet powder decreases.

The average particle size of the crystal grain is preferably less than 2.0 μm. When the average particle size of the crystal grain is less than 2.0 μm, the coercivity of the samarium-iron-nitrogen based magnet according to the present embodiment further increases.

The proportion of the crystal grains having an aspect ratio of 2.0 or more in the crystal grain is preferably 10 number % or less, and further preferably 8 number % or less. When the proportion of the crystal grains having an aspect ratio of 2.0 or more is 10 number % or less, the coercivity of the samarium-iron-nitrogen based magnet powder according to the present embodiment further increases.

The arithmetic mean roughness Ra of the crystal grain is preferably 3.5 nm or less, and further preferably 2.0 nm or less. When the arithmetic mean roughness Ra is 3.5 nm or less, the coercivity of the samarium-iron-nitrogen based magnet powder according to the present embodiment further increases.

The oxygen content of the samarium-iron-nitrogen based magnet powder in the present embodiment is preferably less than 1.0% by mass. When the oxygen content of the samarium-iron-nitrogen based magnet powder according to the present embodiment is less than 1.0% by mass, the coercivity of the samarium-iron-nitrogen based magnet according to the present embodiment further increases.

The crystal structure of the crystal grain of the samarium-iron-nitrogen based magnet powder according to the present embodiment may be either Th₂Zn₁₇ structure or TbCu₇ structure, but the Th₂Zn₁₇ structure is preferable.

### [Method for Manufacturing Samarium-Iron-Nitrogen Based Magnet Powder]

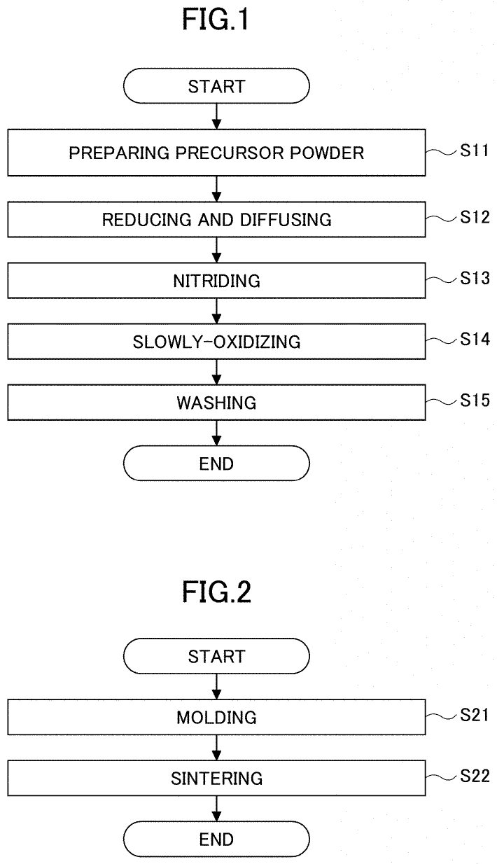

A method of manufacturing a samarium-iron-nitrogen based magnet powder according to the present embodiment includes steps of preparing a precursor powder of a samarium-iron based alloy (S11), preparing a samarium-iron based alloy powder by reducing and diffusing the precursor powder of the samarium-iron based alloy under an inert gas atmosphere (S12), nitriding the samarium-iron based alloy powder (S13), slowly oxidizing a samarium-rich phase (S14), and washing nitride of the samarium-iron based alloy powder with amidosulfuric acid (S15) (see FIG. 1).

Examples of the inert gas include argon and the like. Because it is necessary to control the amount of nitridation of the samarium-iron-nitrogen based magnet powder, it is necessary to avoid using nitrogen gas during reducing and diffusing.

Preferably, the inert gas atmosphere has an oxygen concentration of 1 ppm or less by using a gas purifier and the like.

Hereinafter, the method of manufacturing the samarium-iron-nitrogen based magnet powder according to the present embodiment will be described specifically.

### (Preparing Precursor Powder of Samarium-Iron Based Alloy)

The precursor powder of the samarium-iron based alloy is not particularly limited as long as it is possible to produce the samarium-iron based alloy powder by reducing and diffusing, but includes a samarium-iron based oxide powder, a samarium-iron based hydroxide powder, and the like.

Hereinafter, the samarium-iron based oxide powder and/or the samarium-iron based hydroxide powder is referred to as a samarium-iron based (hydro) oxide powder.

The samarium-iron based alloy powder means a powder of an alloy containing samarium and iron.

The samarium-iron based (hydro) oxide powder may be prepared by a coprecipitation method. Specifically, a precipitating agent such as alkali is added to a solution containing a samarium salt and an iron salt to cause precipitation, and then the precipitate is collected by filtration, centrifugation, and the like. The precipitate is then washed and dried. The precipitate is coarsely pulverized with a blade mill or the like, and then finely pulverized with a bead mill or the like to obtain the samarium-iron based (hydro) oxide powder.

Here, when the samarium-iron-nitrogen based magnet powder contains iron, which exhibits soft magnetism, the magnetic properties are lowered, so samarium is added in excess of the stoichiometric ratio.

Counter ions in the samarium salt and the iron salt may be inorganic ions such as a chloride ion, a sulfate ion, and a nitrate ion, or an organic ion such as an alkoxide.

As a solvent contained in the solution containing the samarium salt or the iron salt, water may be used, and an organic solvent such as ethanol and the like may be used.

As the alkali, hydroxides and ammonia of alkali metals and alkaline earth metals may be used. A compound such as urea that acts as a precipitating agent by being decomposed by an external action such as heat may also be used.

When drying the washed precipitate, a hot air oven may be used, or a vacuum dryer may be used.

The steps after preparing the precursor powder of the samarium-iron based alloy are carried out in a glovebox or the like without exposure to the atmosphere until the samarium-iron-nitrogen based magnet powder is obtained.

### (Pre-Reduction)

The precursor powder of the samarium-iron based alloy is preferably pre-reduced in a reducing atmosphere such as a hydrogen atmosphere, prior to the reducing and diffusing. Accordingly, it is possible to reduce the amount of calcium used and to prevent generation of coarse samarium-iron based alloy particles.

A method of pre-reducing the precursor powder of the samarium-iron based alloy is not particularly limited, but includes a method of heat-treating at a temperature of 400° C. or higher in a reducing atmosphere such as a hydrogen atmosphere and the like.

In order to obtain a samarium-iron based alloy powder with an average particle size of 2 μm or less and a uniform particle size, it is preferable to pre-reduce the precursor powder of the samarium-iron based alloy at 500° C. to 800° C.

### (Reduction and Diffusion)

The method of reducing and diffusing the precursor powder of the samarium-iron based alloy under the inert gas atmosphere is not particularly limited, but includes a method of mixing calcium or calcium hydride with the precursor powder of the samarium-iron based alloy and then heating the powder to a temperature (about 850° C.) that is equal to or higher than the melting point of calcium. In this case, samarium reduced by calcium diffuses in the calcium melt and reacts with iron to form the samarium-iron based alloy powder.

There is a correlation between the temperature of reducing and diffusing and the particle size of the samarium-iron based alloy powder. The higher the temperature of reducing and diffusing, the larger the particle size of the samarium-iron based alloy powder.

In order to obtain a samarium-iron based alloy powder with an average particle size of 2 μm or less and a uniform particle size, it is preferable to perform reducing and diffusing the samarium-iron based oxide powder at 850° C. to 1050° C. for about 1 minute to 2 hours under an inert gas atmosphere.

In the samarium-iron based oxide powder, crystallization progresses as reducing and diffusing progresses, and crystal grains having a Th₂Zn₁₇ structure are formed. The samarium-rich phase is then formed on at least a part of the surface of the crystal grain.

### (Nitriding)

The method of nitriding the samarium-iron based alloy powder is not particularly limited, but includes a method of heat-treating the samarium-iron based alloy powder at 300° C. to 500° C. in an atmosphere such as ammonia, a mixed gas of ammonia and hydrogen, nitrogen, or a mixed gas of nitrogen and hydrogen, and the like.

The composition of the crystal grain constituting the samarium-iron-nitrogen based magnet powder according to the present embodiment is preferably Sm₂Fe₁₇N₃ in order to exhibit high magnetic properties.

When ammonia is used, the samarium-iron based alloy powder can be nitrided in a short time, but the nitrogen content in the samarium-iron-nitrogen based magnet powder may exceed the optimum value. In this case, the samarium-iron based alloy powder may be nitrided and then annealed in hydrogen to expel excess nitrogen from the crystal lattice.

For example, the samarium-iron alloy based powder is heat-treated at 350° C. to 450° C. for 10 minutes to 2 hours under an ammonia-hydrogen mixed atmosphere, and then annealed at 350° C. to 450° C. for 30 minutes to 2 hours under a hydrogen atmosphere. This allows the nitrogen content in the samarium-iron-nitrogen based magnet powder to be optimized.

### (Slowly-Oxidizing of Samarium-Rich Phase)

The samarium-rich phase is formed on at least a part of the surface of the crystal grain, the crystal grain constituting the nitride of the samarium-iron based alloy powder. When the nitride of the samarium-iron based alloy powder is washed, vacuum-dried, and dehydrogenated as described below, a SmFe₅ phase is formed on at least a part of the surface of the crystal grain constituting the samarium-iron-nitrogen based magnet particle, and the coercivity of the samarium-iron-nitrogen based magnet powder decreases. Therefore, before washing the nitride of the samarium-iron based alloy powder, for example, the samarium-rich phase is slowly oxidized by exposure to an oxidizing atmosphere. Accordingly, a samarium oxide phase is formed on at least a part of the surface of the crystal grain constituting the samarium-iron-nitrogen based magnet. As a result, the samarium-iron-nitrogen based magnet powder having high coercivity is obtained.

The oxidizing atmosphere is not particularly limited, but an inert gas atmosphere containing moisture or an inert gas atmosphere containing a small amount of oxygen may be used.

### (Washing)

As described above, because the nitride of the samarium-iron based alloy powder contains a calcium compound, the nitride of the samarium-iron based alloy powder is washed with amidosulfuric acid to remove the calcium compound.

At this time, before washing the nitride of the samarium-iron based alloy powder with amidosulfuric acid, it may be washed with water, alcohol, or the like.

For example, by repeating the operation of adding water to the nitride of the samarium-iron alloy based powder and then stirring and decanting, most of the calcium compound can be removed.

When washing the nitride of the samarium-iron based alloy powder with amidosulfuric acid, it is preferable to use a weakly acidic aqueous solution of amidosulfuric acid with a pH of 3 to 6, more preferably, with a pH of 4.5 to 5.5. Accordingly, the calcium compound can be selectively removed from the nitride of the samarium-iron based alloy powder.

The samarium-iron based alloy powder may be washed before nitriding the samarium-iron based alloy powder.

### (Vacuum-Drying)

The washed nitride of the samarium-iron based alloy powder is preferably vacuum-dried.

The temperature at which the washed nitride of the samarium-iron based alloy powder is vacuum-dried is preferably ambient temperature to 100° C. Accordingly, the oxidation of the washed nitride of the samarium-iron based alloy powder can be reduced.

The washed nitride of the samarium-iron based alloy powder may be replaced with an organic solvent such as alcohol which is highly volatile and miscible with water, and then vacuum-dried.

### (Dehydrogenation)

When washing the nitride of the samarium-iron based alloy powder, hydrogen may enter between crystal lattices. In this case, it is preferable to dehydrogenate the nitride of the samarium-iron based alloy powder.

The method of dehydrogenating the nitride of the samarium-iron based alloy powder is not particularly limited, but includes a method of heat-treating the nitride of the samarium-iron based alloy powder in a vacuum or under an inert gas atmosphere.

For example, the nitride of the samarium-iron based alloy powder is heat-treated at 150° C. to 250° C. for 0 to 1 hour under argon atmosphere.

### (Grinding)

The nitride of the samarium-iron based alloy powder may be ground. Accordingly, the residual magnetization and the maximum energy product of the samarium-iron-nitrogen based magnet powder according to the present embodiment is improved.

In the present application, the term “grind” is used as a separate term from “pulverize”.

That is, “grind” means separating one or more particles from an aggregate in which a plurality of particles are aggregated. In contrast, “pulverize” means dividing a single particle into smaller pieces.

When grinding the nitride of the samarium-iron based alloy powder, a jet mill, a dry and wet ball mill, a vibration mill, a medium agitation mill, and the like may be used.

Instead of grinding the nitride of the samarium-iron based alloy powder, the samarium-iron based alloy powder may be ground.

### [Method of Manufacturing Samarium-Iron-Nitrogen Based Magnet]

A method of manufacturing a samarium-iron-nitrogen based magnet according to the present embodiment includes the steps of molding the samarium-iron-nitrogen based magnet powder according to the present embodiment into a predetermined shape to obtain a molded body (S21) and sintering the molded body (S22) (see FIG. 2).

### (Molding)

The step of molding the samarium-iron-nitrogen based magnet powder according to the present embodiment may be performed while applying a magnetic field. Accordingly, the molded body of the samarium-iron-nitrogen based magnet powder according to the present embodiment is oriented in a specific direction, so that an anisotropic magnet having high magnetic characteristics can be obtained.

### (Sintering)

The method of sintering the samarium-iron-nitrogen based magnet powder according to the present embodiment includes a discharge plasma method, a hot press method, or the like.

The steps of molding and sintering the samarium-iron-nitrogen based magnet powder according to the present embodiment may be performed using the same apparatus.

### EXAMPLE

In the following, examples of the present invention will be described. The present invention is not limited to the examples described below.

### Example 1

### <Preparation of Samarium-Iron-Nitrogen Magnet Powder>

A samarium-iron-nitrogen magnet powder was prepared as follows.

### (Preparation of Samarium-Iron (Hydro) Oxide Powder)

64.64 g of iron nitrate nonahydrate and 12.93 g of samarium nitrate hexahydrate were dissolved in 800 ml of water, and then 120 ml of 2 mol/L potassium hydroxide aqueous solution was added dropwise while stirring. The mixture was stirred overnight at ambient temperature to prepare a suspension. Next, the suspension was filtered and the filtered sample was washed and then dried overnight at 120° C. under an air atmosphere using a hot air oven. The filtered sample was coarsely pulverized with a blade mill and finely pulverized in ethanol with a rotary mill using a stainless steel ball. Next, after centrifuging the finely pulverized sample, it was vacuum-dried to prepare a samarium-iron (hydro) oxide powder.

### (Pre-Reduction)

The samarium-iron (hydro) oxide powder was pre-reduced by heat treatment under a hydrogen atmosphere at 600° C. for 6 hours to prepare a samarium-iron oxide powder.

### (Reducing and Diffusing)

After 5 g of the samarium-iron oxide powder and 2.5 g of calcium powder were placed in an iron crucible, it was heated at 900° C. for 1 hour to be reduced and diffused such that a samarium-iron alloy powder was prepared.

### (Nitriding)

After cooling the samarium-iron alloy powder to ambient temperature, the temperature was raised to 380° C. under a hydrogen atmosphere. Then, the temperature was raised to 420° C. under an ammonia-hydrogen mixture atmosphere whose volume ratio is 1:2, and held for 1 hour so that the samarium-iron alloy powder was nitrified to prepare a samarium-iron-nitrogen magnet powder. Next, the nitrogen content in the samarium-iron-nitrogen magnet powder was optimized by annealing at 420° C. for 1 hour under a hydrogen atmosphere, and then annealing at 420° C. for 0.5 hours under an argon atmosphere.

### (Slow Oxidation)

The samarium-iron-nitrogen magnet powder with optimized nitrogen content was exposed to moisture-containing argon gas overnight to slowly oxidize. Here, the moisture-containing argon gas was prepared by aerating argon gas to water.

### (Washing)

The samarium-iron-nitrogen magnet powder with optimized nitrogen content was washed five times with pure water. Then, the samarium-iron-nitrogen magnet powder was washed to remove a calcium compound by adding an amidosulfuric acid aqueous solution to adjust the pH to 5 and maintaining the pH for 15 minutes. The samarium-iron-nitrogen magnet powder was then washed with pure water to remove amidosulfuric acid.

### (Vacuum-Drying)

Water remaining in the washed samarium-iron-nitrogen magnet powder was replaced with 2-propanol and then the powder was vacuum-dried at ambient temperature.

### (Dehydrogenation)

The vacuum-dried samarium-iron-nitrogen magnet powder was dehydrogenated under vacuum at 200° C. for 3 hours.

Note that, steps subsequent to pre-reduction were performed in a glove box under an argon atmosphere without exposure to air.

The samarium-iron-nitrogen magnet powder prepared as described above was used as a raw material for a samarium-iron-nitrogen sintered magnet. As described below, the properties of the samarium-iron-nitrogen magnet powder prepared as described above were examined.

### <Preparation of Samarium-Iron-Nitrogen Sintered Magnet>

A samarium-iron-nitrogen magnet was prepared as follows.

### (Molding)

In a glove box, a cuboid die made of cemented carbide having a vertical length of 5.5 mm and a horizontal length of 5.5 mm was filled with 0.5 g of the samarium-iron-nitrogen magnet powder. Thereafter, it was placed in a discharge plasma sintering apparatus provided with a pressurizing mechanism by a servo-controlled press device without exposure to air.

### (Sintering)

In a state in which the discharge plasma sintering apparatus was vacuumed (pressure of 2 Pa or less and oxygen concentration of 0.4 ppm or less), under conditions of a pressure of 1200 MPa and a temperature of 500° C., the samarium-iron-nitrogen magnet powder was energized and sintered for 1 minute to prepare a samarium-iron-nitrogen sintered magnet. Here, after the samarium-iron-nitrogen magnet powder was energized and sintered, the pressure was returned to the atmospheric pressure with an inert gas, and after the temperature became 60° C. or less, the samarium-iron-nitrogen sintered magnet was taken out into the atmosphere.

The properties of the samarium-iron-nitrogen sintered magnet prepared as described above were evaluated.

### Example 2

A samarium-iron-nitrogen sintered magnet was prepared in a manner similar to Example 1, except that, in (Preparation of Samarium-Iron (Hydro) Oxide Powder), 58.18 g of iron nitrate nonahydrate were used instead of 64.64 g of iron nitrate nonahydrate, and 4.66 g of cobalt nitrate hexahydrate were used.

### Example 3

A samarium-iron-nitrogen sintered magnet was prepared in a manner similar to Example 1, except that, in (Washing), the pH was adjusted to 5 by adding an amidosulfuric acid aqueous solution and the pH was maintained for 5 minutes.

### Example 4

A samarium-iron-nitrogen sintered magnet was prepared in a manner similar to Example 1, except that, in (Washing), the pH was adjusted to 5 by adding an amidosulfuric acid aqueous solution and the pH was maintained for 60 minutes.

### Comparative Example 1

A samarium-iron-nitrogen sintered magnet was prepared in a manner similar to Example 1, except that, in (Washing), the amidosulfuric acid solution was not used.

### Comparative Example 2

A samarium-iron-nitrogen sintered magnet was prepared in a manner similar to Example 1, except that, in (Washing), the pH was adjusted to 7 by adding diluted acetic acid instead of adding the amidosulfuric acid aqueous solution.

### Comparative Example 3

A samarium-iron-nitrogen sintered magnet was prepared in a manner similar to Example 1, except that, in (Washing), the pH was adjusted to 5 by adding diluted acetic acid instead of adding the amidosulfuric acid aqueous solution.

### Example 5

A samarium-iron-nitrogen sintered magnet was prepared in a manner similar to Example 1 except that, in (Preparation of Samarium-Iron-(Water) Oxide Powder), 9.48 g of samarium nitrate hexahydrate was added.

### Comparative Example 4

A samarium-iron-nitrogen sintered magnet was prepared in a manner similar to Example 5, except that, in (Washing), the amidosulfuric acid aqueous solution was not used.

### Example 6

The samarium-iron-nitrogen sintered magnet was prepared in a manner similar to Example 1, except that, in (Reducing and Diffusing), it was heated at 1010° C. for 1 hour.

### Comparative Example 5

A samarium-iron-nitrogen sintered magnet was prepared in a manner similar to Example 6, except that, in (Washing), the amidosulfuric acid aqueous solution was not used.

Next, X-ray diffraction (XRD) spectra of the samarium-iron-nitrogen sintered magnets of Examples 1 to 6 and Comparative Examples 1 to 5 were measured. It was confirmed that the crystal grains of the samarium-iron-nitrogen sintered magnets of Examples 1 to 6 and Comparative Examples 1 to 5 had a Th₂Zn₁₇ structure. Also, the nitrogen contents of the samarium-iron-nitrogen sintered magnets of Examples 1 to 6 and Comparative Examples 1 to 5 were measured by an inert gas fusion-thermal conductivity method. It was confirmed that the nitrogen contents were each approximately 3.3% by mass, and that the nitrogen contents of the samarium-iron-nitrogen sintered magnets of Examples 1 to 6 and Comparative Examples 1 to 5 were suitable for expressing high magnetic properties.

Next, the properties of the samarium-iron-nitrogen sintered magnets were evaluated.

### [Average Particle Size of Crystal Grain, and Proportion of Crystal Grains Having Aspect Ratio of 2.0 or More]

A scanning electron microscope (FE-SEM) was used to observe a cross-section of the samarium-iron-nitrogen sintered magnet and 200 or more randomly selected grains are outlined.

The outline of the crystal grain consists of the surface of the crystal grain and/or the surfaces of the crystal grains that are in contact. The crystal grains that are in contact can be distinguished by FE-SEM backscattered electron image or by energy dispersive X-ray spectroscopy (EDS) mapping.

Next, the proportion of the crystal grains having an aspect ratio of 2.0 or more was obtained by calculating the average particle size of the crystal grains by arithmetic averaging the particle sizes of the crystal grains, and by calculating the aspect ratio of the crystal grains.

Here, the particle size of the crystal grain is a diameter of a circle having the same area as the region enclosed by the outline of the crystal grain.

The aspect ratio of the crystal grain is a value obtained by dividing the length of the long side by the length of the short side of a square that circumscribes the outline of the crystal grain and has the smallest area.

### [Presence or Absence of Samarium Oxide Phase on Surface of Crystal Grain]

A scanning transmission electron microscope (STEM) and energy dispersive X-ray spectroscopy (EDS) were used to observe the cross-section of the samarium-iron-nitrogen sintered magnet to determine the presence or absence of a samarium oxide phase on the surface of the crystal grain.

[Arithmetic Mean Roughness Ra of Crystal Grain (nm)]

The arithmetic mean roughness Ra of the crystal grain was determined as follows. In the scanning transmission electron microscope (STEM) images of the samarium-iron-nitrogen sintered magnet, a center line was drawn for the outline of the crystal grain and the irregularities of the outline, and the length from the center line to the outline was measured at 50 or more points at equal intervals, and then the average value was obtained.

When the arithmetic mean roughness Ra of the crystal grains was 1 or less, it was determined as “1 or less” because the analysis error was large.

### [Atomic Ratio of Ca to Total Amount of Iron Group Elements, Rare Earth Elements, and Ca]

The composition of the samarium-iron-nitrogen sintered magnet was analyzed by high frequency inductively coupled plasma emission spectroscopy, and the atomic ratio of Ca to the total amount of iron group elements, rare-earth elements, and Ca was calculated.

### [Oxygen Content]

The oxygen content of the samarium-iron-nitrogen sintered magnet was measured by an inert gas fusion-nondispersive infrared absorption method.

### [Coercivity]

The coercivity of the samarium-iron-nitrogen sintered magnet was measured using a vibrating sample magnetometer (VSM) at a temperature of 27° C. and a maximum applied magnetic field of 90 kOe.

Table 1 describes the evaluation results of the properties of the samarium-iron-nitrogen sintered magnets.

TABLE 1

| | | | | | ATOMIC RATIO | | |
|---|---|---|---|---|---|---|---|
| | CRYSTAL GRAIN | | | | OF Ca TO | | |
| | | PROPORTION | | | TOTAL AMOUNT | | |
| | | OF CRYSTAL | | | OF IRON GROUP | | |
| | AVERAGE | GRAIN HAVING | SAMARIUM | | ELEMENTS, | OXYGEN | |
| | PARTICLE | ASPECT RATIO | OXIDE | | RARE EARTH | CONTENT | COER- |
| | SIZE | OF 2.0 OR MORE | PHASE ON | Ra | ELEMENTS, AND | [% BY | CIVITY |
| | [μm] | [NUMBER %] | SURFACE | [nm] | Ca [%] | MASS] | [k0e] |
| EXAMPLE | 0.60 | 6 | PRESENT | 1 OR LESS | 0.25 | 0.8 | 16.4 |
| 1 | | | | | | | |
| EXAMPLE | 0.60 | 6 | PRESENT | 1 OR LESS | 0.25 | 0.8 | 16.5 |
| 2 | | | | | | | |
| EXAMPLE | 0.60 | 6 | PRESENT | 1 OR LESS | 0.35 | 0.9 | 16.1 |
| 3 | | | | | | | |
| EXAMPLE | 0.60 | 6 | PRESENT | 2.0 | 0.10 | 0.7 | 16.1 |
| 4 | | | | | | | |
| COM- | 0.60 | 6 | PRESENT | 1 OR LESS | 2.10 | 2.1 | 12.1 |
| PARATIVE | | | | | | | |
| EXAMPLE | | | | | | | |
| 1 | | | | | | | |
| COM- | 0.60 | 6 | PRESENT | 1 OR LESS | 1.00 | 1.5 | 12.3 |
| PARATIVE | | | | | | | |
| EXAMPLE | | | | | | | |
| 2 | | | | | | | |
| COM- | 0.60 | 6 | PRESENT | 3.9 | 0.05 | 0.7 | 14.1 |
| PARATIVE | | | | | | | |
| EXAMPLE | | | | | | | |
| 3 | | | | | | | |
| EXAMPLE | 0.35 | 8 | PRESENT | 1 OR LESS | 0.08 | 0.7 | 20.1 |
| 5 | | | | | | | |
| COM- | 0.35 | 8 | PRESENT | 1 OR LESS | 1.41 | 1.7 | 15.0 |
| PARATIVE | | | | | | | |
| EXAMPLE | | | | | | | |
| 4 | | | | | | | |
| EXAMPLE | 1.90 | 4 | PRESENT | 1 OR LESS | 0.10 | 0.7 | 10.1 |
| 6 | | | | | | | |
| COM- | 1.90 | 4 | PRESENT | 1 OR LESS | 1.00 | 1.5 | 5.8 |
| PARATIVE | | | | | | | |
| EXAMPLE | | | | | | | |
| 5 | | | | | | | |

From Table 1, it can be seen that the samarium-iron-nitrogen sintered magnets of Examples 1 to 6 have high coercivity.

In contrast, the samarium-iron-nitrogen sintered magnets of Comparative Examples 1, 2, 4, and 5 have low coercivity because the atomic ratio of calcium to the total amount of iron group elements, rare earth elements, and calcium is 1.0% to 2.1%.

The samarium-iron-nitrogen sintered magnet of Comparative Example 3 has low coercivity because the samarium oxide phase is not formed on the surface of the crystal grain.

### [Preparation of Samples for Examining Properties of Samarium-Iron-Nitrogen Magnet Powder]

The samarium-iron-nitrogen magnet powder and a thermosetting epoxy resin were kneaded and thermally cured, and then etched by irradiation with a focused ion beam (FIB) to expose a cross-section to prepare a sample.

### [Properties of Samarium-Iron-Nitrogen Magnet Powder]

In a manner similar to the evaluation described above, except that the sample described above was used instead of the samarium-iron-nitrogen sintered magnet, the average particle size of the crystal grain, the proportion of the crystal grains having an aspect ratio of 2.0 or more, the presence or absence of a samarium oxide phase on the surface of the crystal grain, and the arithmetic mean roughness Ra of the crystal grain were examined. The properties of the samarium-iron-nitrogen magnet powder were comparable to those of the samarium-iron-nitrogen sintered magnet.

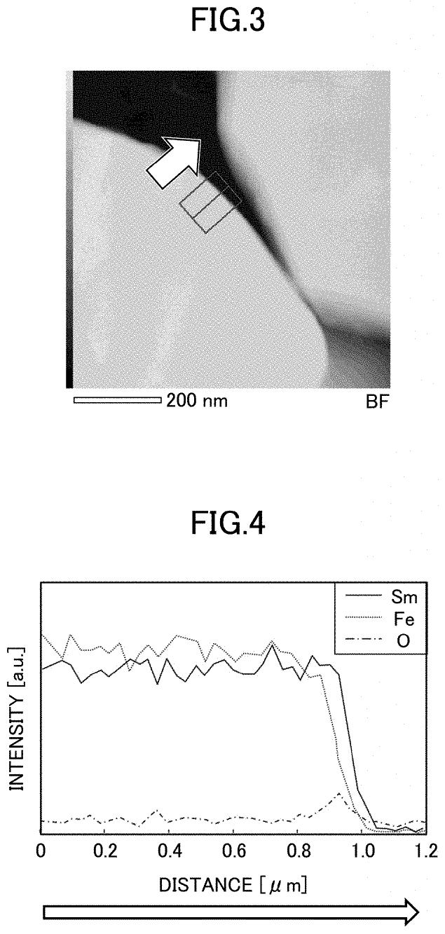

FIGS. 3 and 4 illustrate a cross-sectional STEM image and a result of line analysis of the samarium-iron-nitrogen based magnet powder of Example 1, respectively.

Here, the arrows in FIG. 3 represent the measurement range and the measurement direction of the line analysis. Near the distance of 0.9 μm in FIG. 4 is the surface of the crystal grain.

From FIG. 4, it can be seen that a phase in which the atomic ratio of the rare earth element to the iron group element is larger than that of the crystal grain, that is, an oxidized phase is formed on the surface of the crystal grain.

In a manner similar to the evaluation described above, except that the samarium-iron-nitrogen magnet powder was used instead of the samarium-iron-nitrogen sintered magnet, the atomic ratio of calcium to the total amount of iron group elements, rare earth elements, and calcium, oxygen content were examined. The properties of the samarium-iron-nitrogen magnet powder were comparable to those of the samarium-iron-nitrogen sintered magnet.

### [Preparation of Samples for Examining Coercivity of Samarium-Iron-Nitrogen Magnet Powder]

The samarium-iron-nitrogen magnet powder and a thermoplastic resin were mixed and then oriented in a magnetic field of 20 kOe to prepare a sample.

### [Coercivity of Samarium-Iron-Nitrogen Magnet Powder]

Using a vibrating sample magnetometer (VSM), under conditions of a temperature of 27° C. and a maximum applied magnetic field of 90 kOe, the sample was arranged in an easily magnetizable axial direction and the coercivity of the samarium-iron-nitrogen magnet powder was measured.

Table 2 describes the evaluation results of the coercivity of the samarium-iron-nitrogen magnet powder.

TABLE 2

| | COERCIVITY OF | COERCIVITY OF MAGNET/ |
|---|---|---|
| | MAGNET POWDER | COERCIVITY OF MAGNET |
| | [kOe] | POWDER |
| EXAMPLE 1 | 24.9 | 0.66 |
| EXAMPLE 2 | 25.0 | 0.66 |
| COMPARATIVE | 27.3 | 0.44 |
| EXAMPLE 1 | | |
| COMPARATIVE | 27.8 | 0.44 |
| EXAMPLE 2 | | |
| COMPARATIVE | 21.8 | 0.65 |
| EXAMPLE 3 | | |

From Table 2, it can be seen that, in the samarium-iron-nitrogen magnet powders of Examples 1 and 2, the coercivity of the magnet powder and the ratio of the coercivity of the magnet to the coercivity of the magnet powder are high.

In contrast, in the samarium-iron-nitrogen magnet powders of Comparative Examples 1 and 2, the ratio of the coercivity of the magnet to the coercivity of the magnet powder is low because the atomic ratio of calcium to the total amount of iron group elements, rare earth elements, and calcium are 1.00% to 2.10%.

In addition, in the samarium-iron-nitrogen magnet powder of Comparative Example 3, the value of the coercivity of the magnet powder is low because the samarium oxide phase is not formed on the surface of the crystal grain.

### Example 7

A samarium-iron-nitrogen sintered magnet was prepared in a manner similar to Example 1.

In Example 7, in (Washing), the maintaining time of the samarium-iron-nitrogen magnet powder in the amidosulfuric acid aqueous solution was set to 120 minutes.

### Example 8

A samarium-iron-nitrogen sintered magnet was prepared in a manner similar to Example 1.

In Example 8, in (Reducing and Diffusing), the samarium-iron oxide powder was heated at 945° C. for 1 hour.

### Comparative Example 6

A samarium-iron-nitrogen sintered magnet was prepared in a manner similar to Example 1.

In Comparative Example 6, in (Reducing and Diffusing), the samarium-iron oxide powder was heated at 945° C. for 1 hour. In addition, in (Washing), no washing was performed using the amidosulfuric acid aqueous solution.

### Example 9

A samarium-iron-nitrogen sintered magnet was prepared in a manner similar to Example 1.

In Example 9, in (Reducing and Diffusing), the samarium-iron oxide powder was heated at 960° C. for 1 hour.

### Comparative Example 7

A samarium-iron-nitrogen sintered magnet was prepared in a manner similar to Example 1.

In Comparative Example 7, in (Reducing and Diffusing), the samarium-iron oxide powder was heated at 960° C. for 1 hour. In addition, in (Washing), no washing was performed using the amidosulfuric acid aqueous solution.

### Example 10

A samarium-iron-nitrogen sintered magnet was prepared in a manner similar to Example 5.

In Example 10, in (Washing), the maintaining time of the samarium-iron-nitrogen magnet powder in the amidosulfuric acid aqueous solution was set to 120 minutes.

### Comparative Example 8

A samarium-iron-nitrogen sintered magnet was prepared in a manner similar to Example 1.

In Comparative Example 8, commercially available samarium-iron-nitrogen coarse powder was prepared as a raw material. The average particle size of the coarse powder was 25 μm. The coarse powder was pulverized by a ball mill using dehydrated hexane as a solvent for 6 hours to prepare a samarium-iron-nitrogen magnet powder.

Table 3 below describes the evaluation results of the properties of the samarium-iron-nitrogen sintered magnets of Examples 7 to 10 and Comparative Examples 6 to 8.

| | | | | | ATOMIC RATIO | | |
|---|---|---|---|---|---|---|---|
| | CRYSTAL GRAIN | | | | OF Ca TO | | |
| | | PROPORTION | | | TOTAL AMOUNT | | |
| | | OF CRYSTAL | | | OF IRON GROUP | | |
| | AVERAGE | GRAIN HAVING | SAMARIUM | | ELEMENTS, | OXYGEN | |
| | PARTICLE | ASPECT RATIO | OXIDE | | RARE EARTH | CONTENT | COER- |
| | SIZE | OF 2.0 OR MORE | PHASE ON | Ra | ELEMENTS, AND | [% BY | CIVITY |
| | [μm] | [NUMBER %] | SURFACE | [nm] | Ca [%] | MASS] | [k0e] |
| EXAMPLE | 0.60 | 6 | PRESENT | 3.5 | 0.04 | 0.4 | 15.9 |
| 7 | | | | | | | |
| EXAMPLE | 1.00 | 6 | PRESENT | 1 OR LESS | 0.20 | 0.8 | 13.5 |
| 8 | | | | | | | |
| COM- | 1.00 | 6 | PRESENT | 1 OR LESS | 1.81 | 1.9 | 9.2 |
| PARATIVE | | | | | | | |
| EXAMPLE | | | | | | | |
| 6 | | | | | | | |
| EXAMPLE | 1.20 | 6 | PRESENT | 1 OR LESS | 0.18 | 0.8 | 12.3 |
| 9 | | | | | | | |
| COM- | 1.20 | 6 | PRESENT | 1 OR LESS | 1.64 | 1.8 | 8.0 |
| PARATIVE | | | | | | | |
| EXAMPLE | | | | | | | |
| 7 | | | | | | | |
| EXAMPLE | 0.35 | 8 | PRESENT | 3.5 | 0.01 | 0.4 | 19.6 |
| 10 | | | | | | | |
| COM- | 0.97 | 22 | ABSENT | 6.2 | 0.01 | 0.6 | 8.5 |
| PARATIVE | | | | | | | |
| EXAMPLE | | | | | | | |
| 8 | | | | | | | |

From Table 3, it can be seen that, in the samarium-iron-nitrogen sintered magnets of Examples 7 to 10, the coercivity are at least 12 kOe or more, and high coercivity is obtained.

In contrast, in the samarium-iron-nitrogen sintered magnet of Comparative Examples 6 to 8, the coercivity are at most less than 10 kOe.

In the samarium-iron-nitrogen sintered magnets of Comparative Examples 6 and 7, the atomic ratio of calcium to the total amount of iron-group elements, rare-earth elements, and calcium is as high as 1.64% to 1.81%. It is considered that the samarium-iron-nitrogen sintered magnets of Comparative Examples 6 and 7 were washed insufficiently because no washing with the amidosulfuric acid aqueous solution was performed in the washing step, resulting in a decrease in coercivity.

In the samarium-iron-nitrogen sintered magnet of Comparative Example 8, the samarium oxide phase is not formed on the surface of the crystal grain. It is considered that this is the reason why low coercivity was obtained in the samarium-iron-nitrogen sintered magnet of Comparative Example 8.

### INDUSTRIAL APPLICABILITY

The samarium-iron-nitrogen based magnet according to the present embodiment is mounted, for example, on home appliances such as air conditioners, production robots, automobiles, and the like. The samarium-iron-nitrogen based magnet powder according to the present embodiment may be used, for example, as raw materials for sintered magnets and bonded magnets used in motors, sensors, and the like.

The present application claims priority to Japanese Patent Application No. 2020-060803, filed Mar. 30, 2020, with the Japanese Patent Office, the contents of which are incorporated herein by reference in their entirety.

1. A samarium-iron-nitrogen based magnet,
wherein a samarium oxide phase is formed on at least a part of a surface of a crystal grain, and
wherein an atomic ratio of calcium to a total amount of iron group elements, rare earth elements, and calcium is 0.4% or less.

2. The samarium-iron-nitrogen based magnet according to claim 1, wherein the crystal grain has an average particle size of less than 2.0 μm, and a proportion of crystal grains having an aspect ratio of 2.0 or more is 10 number % or less.

3. The samarium-iron-nitrogen based magnet according to claim 1, wherein an arithmetic mean roughness Ra of the crystal grain is 3.5 nm or less.

4. The samarium-iron-nitrogen based magnet according to claim 1, wherein an oxygen content is less than 1.0% by mass.

5. A samarium-iron-nitrogen based magnet powder,
wherein a samarium oxide phase is formed on at least a part of a surface of a crystal grain, and
wherein an atomic ratio of calcium to a total amount of iron group elements, rare earth elements, and calcium is 0.4% or less.

6. The samarium-iron-nitrogen based magnet powder according to claim 5, wherein the crystal grain has an average particle size of less than 2.0 μm, and a proportion of crystal grains having an aspect ratio of 2.0 or more is 10 number % or less.

7. The samarium-iron-nitrogen based magnet powder according to claim 5, wherein an arithmetic mean roughness Ra of the crystal grain is 3.5 nm or less.

8. The samarium-iron-nitrogen based magnet powder according to claim 5, wherein an oxygen content is less than 1.0% by mass.
